(19) United States
(12) Patent Application Publication
(10) Pub. No.: US 2006/0115759 A1
(43) Pub. Date: Jun. 1, 2006

(54) Preparation method of a polyester particle dispersion and polyester particle dispersion prepared by the same

(75) Inventors: Sang-woo Kim, Seoul (KR); Young-ho Lee, Pyeongtaek-si (KR); Seong-geun Oh, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/227,083

(22) Filed: Sep. 16, 2005

(30) Foreign Application Priority Data
Nov. 26, 2004 (KR) 2004-98051

(51) Int. Cl. G03G 9/087

(52) U.S. Cl. 430/109.4; 430/137.15; 528/272

(57) ABSTRACT

A preparation method of a polyester particle dispersion includes: under predetermined depolymerization conditions, mixing a polyester binder resin, a resin dissolvent and a polycondensation catalyst to depolymerize the polyester resin and form a first reaction mixture; adding a first monomer to the first reaction mixture to form a second reaction mixture; under predetermined polymerization conditions, adding a second monomer to the second reaction mixture to polymerize the depolymerized polyester resin and form a third reaction mixture; adding a neutralizing agent to neutralize the polymerized reaction product of the third reaction mixture; (e) adding a reverse-neutralizing agent to reverse neutralize the neutralized mixture; and adding a mixture of an anionic surfactant and a nonionic surfactant to the reverse-neutralized mixture.

### CROSS-REFERENCE TO RELATED APPLICATIONS

This application claims benefit under 35 U.S.C. § 119 from Korean Patent Application No. 2004-98051, filed on Nov. 26, 2004, the entire content of which is incorporated herein by reference.

### BACKGROUND OF THE INVENTION

1. Field of the Invention

The present invention relates in general to a preparation method of a polyester particle dispersion, more particularly, to a preparation method of a polyester resin particle dispersion for the production of a dry toner used in a printer, and a polyester resin particle dispersion obtained by the preparation method of the invention.

2. Description of the Related Art

Toners for laser beam printers are largely classified into two groups: dry toners and liquid toners. Dry toners usually contain binder resins, colorants and other additives.

Among them, the binder resin comprises approximately 90 wt. % of the total weight of the toner, and is responsible for fixing toner particles onto a printing paper. Therefore, the binder resin is the key ingredient, having the biggest influence on the performance of the toner. Depending on the preparation method of the toner, different kinds of binder resins are used.

The colorant provides a color to the toner. Colorants are secondary processed products that are prepared by adding a vehicle, a resin and a stabilizing agent to dyestuff or pigments in general. Dyestuff is a coloring matter having an affinity for a fiber, namely, dyeability, and generally contains aromatic rings. The pigment is a coloring powder in white or other colors that is insoluble both in water and oil. The pigment imparts color perceivable by the human eye by selectively reflecting or transmitting visible rays with the chemical structure or particles. Although the pigment has extremely fine particles, unlike the dyestuff, it is insoluble in many solvents, and therefore requires a vehicle. In general, the colorant used in the toner preparation is a pigment.

Colorants provide different colors such as carbon black, and other colors such as blue, brown, cyan, green, purple, magenta, red, yellow and mixed colors thereof. Examples of pigments include anthraquinone, phthalocyanine blue, phthalocyanine green, diazos, monoazos, pyranthrone, perylene, quinacridone, and indigo pigments.

Besides the above-described ingredients, the toner may contain other additives for improving physical properties.

There are diverse methods for preparing a dry toner. As far as the toner is concerned, the characteristics of the toner particles, such as the shape and the size, are very important since they are very closely related to the resolution of a final print image. To get a high resolution image, toner particles must be spherical and as uniform as possible. Therefore, there is considerable interest in developing a preparation method for a more spherical, finer, and more uniform range size distribution of toner particles.

In general, the preparation methods of a dry toner are classified into pulverization, polymerization and other chemical methods. According to the pulverization (or milling) method, a binder resin, a colorant, a charge control agent and other additives are preliminarily mixed, uniformly dispersed, and pulverized again.

In consideration of the aforementioned requirements of toner particle characteristics, the toner produced by pulverization has several problems, such as great variations of particle size and shape, and poor yield from the final pulverization process. Additionally, it is difficult to obtain uniformly spherical fine toner articles.

Taking the above shortcomings of the pulverization method into account, a polymerization method would be preferable in preparation of the toner particles. According to the polymerization method, the raw materials for toner preparation are mixed and polymerized. Examples of the polymerization method include suspension polymerization and emulsion polymerization.

The suspension polymerization is a method wherein water-insoluble monomers are converted to about 10 μm-diameter oil droplets and dispersed in water for polymerization. The method utilizes a lipophilic polymerization initiator and requires a vehicle for stabilizing the oil droplets.

The emulsion polymerization is a method wherein oil-soluble monomers are emulsified by utilizing an emulsifying agent, and polymerization is initiated with a water-soluble initiator. An ‘emulsifying agent’ includes all the substances that make two non-mixable liquids into a stable emulsion, such as a surfactant which emulsifies water and a water-insoluble organic matter together. A surfactant is an additive that readily adsorbs to the surface and forms micelles when exceeding a critical micelle concentration.

As a rule, the emulsion polymerization takes place in the micelles containing monomer, resulting in polymers of a high degree of polymerization. A micelle is formed as the molecules or ions of surfactants in aqueous phase aggregate when they reach the critical micelle concentration. In the aqueous phase, a polymerization initiator is radicalized, and a monomer bonded to the radicalized initiator is trapped in the micelle for polymerization. Since the polymerization of monomers takes place within the micelle, the emulsion polymerization method is also applicable to synthesis of submicroscopic micro gel (tens of nm in diameter).

When a toner is prepared by emulsion polymerization, latex is usually used as the binder resin. Latex is the milky white fluid contained in the tissue beneath the bark of the Para rubber tree or Hevea brasiliensis. Rubber particles are dispersed in water (the dispersion medium) forming colloid phase. Latex is used as a generic name for natural rubber latex, synthetic rubber, and synthetic resin emulsions of a non-rubber group. Examples of monomers used in production of latex are styrene, divinyl benzene, n-butyl acrylate, methacrylate and acrylic acid.

Toner preparation based on the emulsion polymerization method using latex as the binder resin is disclosed in U.S. Pat. No. 6,120,967. According to the disclosure, a monomer selected from a group consisting of styrene, butyl acrylate, and acrylic acid is mixed with an anionic surfactant and an initiator, and the mixture undergoes a polymerization reaction at a predetermined polymerization temperature to produce latex, the binder resin. The produced latex is then mixed with a colorant and a wax that is used as a releasing agent. Later, a coagulant is added to the emulsion for agglomeration, and the resulting agglomerated particles are melted to produce a toner.

As mentioned earlier, compared to other preparation methods, the emulsion polymerization method using latex is more useful for producing fine and uniform spherical particles. Although there is a variety of monomers that may be readily used or commercially available for the emulsion polymerization, styrene/acrylate latex is used most frequently.

Styrene is a general purpose material used in chemical engineering of resins, synthetic rubbers and paints. Acrylic acid is an easy-to-polymerize material obtained by the direct oxidation of propylene or hydrolysis of acrylonitrile with sulfuric acid. Therefore, styrene and acrylic acid (methacrylic acid) are often used in the production of latex products. To use styrene/acrylate(methacrylate) latex resin for the toner, however, high-level physical properties in thermal or mechanical aspects are required. Also, the low-transparency of the styrene/acrylate(methacrylate) latex resin may present a problem for expressing a color of the toner. Developed later as an answer to the problem is a polyester resin.

U.S. Pat. No. 6,203,957 disclosed a toner preparation method using a polyester resin as a binder resin. According to the disclosure, monomers were polymerized to produce a self-dispersive polyester resin in water. The polyester resin was then dissolved in an organic solvent and mixed with aqueous ammonia as a neutralizing agent. The mixture was dropped into a aqueous medium containing acid to form particles. The resulting particles were filtered, dried, and mixed with a colorant and other additive(s) to produce toner particles.

It is a known fact that polyester resin has superior thermal and mechanical physical properties and excellent color expressive power compared to the existing styrene/acrylate latex. However, the preparation method of polyester resin is somewhat questionable. For instance, U.S. Pat. No. 6,203,957 suggested that a polyester resin should be dissolved in an organic solvent that dissolves the polyester resin, and dispersed in an aqueous medium. In effect, this is the basis of the production of polyester resin for use in a toner. A frequently used organic solvent for polyester resin is tetrahydrofuran (THF), which is yet hazardous substance causing severe damage to the body of a user and environment contamination problems.

In addition, when a toner is produced using the conventional polyester binder resin, it is very difficult to produce fine particles with a diameter of less than 1 μm from the dispersion. Thus, the aforementioned emulsion polymerization method becomes ineffective.

Therefore, there is a need to develop a new preparation method of a dry toner using a polyester resin as a binder resin, in which the dissolution operation in an organic solvent (that is not environmentally friendly) is removed, and the emulsion polymerization is used.

### SUMMARY OF THE INVENTION

It is, therefore, an aspect of an embodiment of the present invention to provide a preparation method of a polyester resin particle dispersion, in which polyester resin particles are dissolved in a resin dissolvent, not in a hazardous organic solvent, for polymerization, and dispersed in a mixture of anionic and nonionic surfactants; and a polyester resin particle dispersion obtained by the same.

To achieve the above aspects and advantages, a preparation method of a polyester particle dispersion includes: under predetermined depolymerizing conditions, mixing a polyester resin, a resin dissolvent and a polycondensation catalyst, and depolymerizing the polyester resin to form a first reaction mixture; adding a first monomer to the first reaction mixture to form a second reaction mixture; under predetermined polymerizing conditions, adding a second monomer to the second reaction mixture to polymerize the depolymerized polyester resin to form a third reaction mixture; adding a neutralizing agent to the polymerized reactant for a neutralization reaction; adding a reverse-neutralizing agent to the neutralized mixture for a reverse-neutralizing reaction; and adding one or more surfactants to the reverse-neutralized mixture.

Preferably, the polyester resin is selected from a group consisting of bisphenol A polyester resins and polyethylene terephthalate (PET) polyester resins, and the resin dissolvent is selected from a group consisting of gum rosins, wood rosins, tall rosins, rosin esters, and C₅ to C₉ petroleum resins.

Preferably, the polycondensation catalyst is dibutyltinoxide (DBTO), the first and second monomers are polycondensing monomers, and the first monomer is selected from a group consisting of maleic acid, phthalic anhydride, isophthalic acid, and terephthalic acid.

Preferably, the second monomer is selected from a group consisting of ethylene glycol, propylene glycol, and bisphenol A alkylene oxide (bisphenol A-EO).

Preferably, the neutralizing agent is a basic compound, and the basic compound is selected from a group consisting of sodium hydroxide, potassium hydroxide, lithium hydroxide, calcium hydroxide, sodium carbonate, and ammonia. Also, a ratio of the resin dissolvent to the polyester resin ranges from 1:9 to 9:1 by weight.

Also, the reverse-neutralizing agent is an acid, preferably, hydrochloric acid.

Preferably, the surfactant is an anionic surfactant or a nonionic surfactant. Preferably, the surfactant is a mixture of an anionic surfactant and a nonionic surfactant, and the anionic surfactant is selected from a group consisting of sodium dodecyl sulfate, sodium 4-dodecylbenzene sulfonate, and sodium polyoxyethylene lauryl ether sulfate. Also, the nonionic surfactant is preferably selected from a group consisting of polyoxylethylene sorbitan monolaurate (Tween 20®) and alkylaryl polyester alcohol (Triton X-100®).

Another aspect of the present invention provides a polyester particle dispersion obtained by the preparation method of an embodiment of the present invention.

Preferably, the polyester particle is 50 nm-400 nm in diameter, and has a glass transition temperature in a range from about 40° C. to about 100° C.

### DETAILED DESCRIPTION OF THE PREFERRED EMBODIMENTS

A preferred example of an embodiment of the present invention will be described herein below.

One example of an embodiment of the present invention provides a preparation method of a polyester particle dispersion, in which a polyester resin is reverse-neutralized and mixed with a surfactant to be dispersed, and the remaining resin dissolvent is separated from the dispersion. Unlike the related art preparation methods, the present invention suggests that a polyester resin should be prepared without using any hazardous organic solvent that may cause damage to a human body and increase environmental contamination. Originally, an organic solvent was used to dissolve the polyester resin. However, embodiments of the present invention use a resin dissolvent instead of the organic solvent for depolymerizing and dissolving the polyester resin.

Preferably, a polyester resin used for producing polyester particles is selected from a group that consists of bisphenol A polyester resins and polyethylene terephthalate (PET) polyester resins. However, other suitable polyester resins may also be used.

A preferable example of the resin dissolvent is a rosin. Rosin is a natural resin in solid form that is obtained from pine trees (pine resin), and chiefly consists of different resin acids, especially abietic acid. Since the rosin has a low softening point and a high acid radical, a plurality of rosin derivatives may be utilized. Examples of resin dissolvent include gum rosins, wood rosins, tall rosins, rosin esters, and C₅ to C₉ petroleum resins. These examples are for illustrative purposes only, so that the resin dissolvent is not limited thereto. Instead of the organic solvent, the resin dissolvent depolymerizes and dissolves the polyester resin.

Then, the depolymerized polyester resin is mixed with a polycondensation catalyst. Examples of the polycondensation catalyst include dibutyltinoxide (DBTO) and other suitable catalysts. Briefly, under predetermined depolymerization conditions, the polyester resin is depolymerized by the resin dissolvent, and the depolymerized resin is polymerized again with a monomer, aided by the polycondensation catalyst.

More specifically, a first monomer using a polybasic acid is added to the mixture of the depolymerized resin and the polycondensation catalyst. Although a polybasic acid is used as the first monomer, a polyhydric alcohol is used as a second monomer to cause another polycondensation reaction to the polyester resin. Examples of the polybasic acid used as the first monomer are maleic acid, phthalic anhydride, isophthalic acid, terephthalic acid, and other suitable polybasic acids of the same kind.

After the first monomer is added, the second monomer is put into the reactant. This operation is particularly important because it is possible to form a polyester resin out of the depolymerized resin using the resin dissolvent, and not an organic solvent for dissolving the polyester resin as in the related art method. Examples of the polyhydric alcohol corresponding to the polybasic acid of the first monomer are ethylene glycol, propylene glycol, bisphenol A alkylene oxide, and other suitable polyhydric alcohols. The polymerization at this time is performed through a polycondensation reaction.

Then, a neutralizing agent is added to neutralize the new polyester resin being produced. Here, the neutralizing agent is a basic compound, and is selected from a group that consists of sodium hydroxide, potassium hydroxide, lithium hydroxide, calcium hydroxide, sodium carbonate, ammonia and other suitable basic compounds.

In detail, to prepare a polyester resin, a polyester resin, a rosin, and DBTO are put in a reactor, and stirred at a reaction temperature for a sufficient amount of time to make sure the depolymerization is fully performed. When the reaction mixture becomes transparent, the temperature is lowered and a first monomer is put into the reactor. Then, the temperature is raised up to the predetermined reaction temperature, and the reaction continues for a predetermined amount of time to complete the polymerization reaction.

When the reaction is complete, a second monomer is put into the reactor and the reaction continues at the predetermined reaction temperature for a predetermined amount of time. After the polycondensation has continued for a predetermined time, the temperature is lowered and a neutralizing agent is added to the reactor. Then, the mixture is stirred for a predetermined amount of time to produce a water-soluble polyester resin dispersion.

By the time the above-described method is completed, the polyester resin used as a starting material of the reaction is completely dissolved to become a water-soluble resin dispersion. At this time, no organic solvent is used for dissolving the polyester resin. Thusly prepared polyester resin forms particles for a binder resin used in the production of a toner.

The resin dispersion neutralized by a basic neutralizing agent is reverse-neutralized using an acid, and mixed with a surfactant. Consequently, the surface of a polyester resin particle is negatively charged. In detail, the water-soluble polyester resin dispersion, which was neutralized at the last operation by the basic neutralizer, is now reversely neutralized by a reverse-neutralizing agent, and mixed with a surfactant. Any acid such as hydrochloric acid or other suitable acids capable of reverse-neutralizing the basic water-soluble polyester resin dispersion may be used as the reverse-neutralizing agent.

In detail, a reverse-neutralizing agent and a surfactant are dissolved in distilled water to prepare an acidic aqueous solution. Meanwhile, at a predetermined temperature, the water-soluble polyester resin dispersion prepared earlier is stirred at a high speed. Then, the acidic aqueous solution is slowly added to the dispersion. Then, the surfactant causes the polyester particle size to be smaller than 1 μm.

Briefly, the polyester resin is reverse-neutralized by an acid, and then mixed with a surfactant. As a result, the polyester resin molecules are surrounded by ions, and the ionic molecules are in a suitable state for toner preparation by applying the emulsion polymerization described above.

Surfactants change the characteristic of the surface (i.e., lower the surface tension) of a liquid and the interfacial tension between two liquids, or gases and solids in solution. Surfactants are usually amphipathic, meaning that they contain both hydrophilic groups and hydrophobic groups. Examples of the hydrophilic groups include carboxylic acid (—COOH), sulfonic acid (—SO₃H) and sulfuric acid ester (—OSO₃H) groups. Examples of the hydrophobic groups include alkyl groups and alkylaryl groups.

Although there are a number of classification methods in use, probably the classification method based on the characteristics of a surface activity of a surfactant in aqueous solution are mostly widely used. For instance, surfactants, when dissolved in water, are classified into: anionic surfactants in which an anion shows a surfactant property; cationic surfactants in which a cation shows a surfactant property; amphoteric surfactants in which either the anion or the cation shows a surfactant property, depending on pH; and nonionic surfactants that are non-dissociative in aqueous solution because of relatively weak hydrophilic groups, such as a hydroxyl group (—OH) and an ether group (—O—). Aside from these surfactants, there are biosurfactants such as lanolin, lecithin and saponin, telomer-type surfactants, fluorine-based surfactants, silicon-based surfactants, and polymer surfactants. Suitable surfactants are selected by application fields.

Among the surfactants, anionic surfactants have been the most widely used surfactants, so there are many kinds of anionic surfactants commercially available. As for the hydrophilic group in an anionic surfactant, carboxylic acids, sulfuric acid esters, and sulfonic acids are used, and more specifically, the anionic surfactant uses carboxylic acids, sulfuric acid esters, and sulfonic acids in the form of soluble salts. Preferable examples of the salts include carboxylic acid salts, such as higher fatty acid alkali salts (soap), N-acrylamino acid salts and acylated peptides; sulfonic acid salts, such as alkylsulfonic acid salts, alkylbenzene sulfonic acid salts, and alkyl naphthalene sulfonic acid salts; sulfuric acid ester salts, such as alkyl sulfuric acid salts, alkyl ether sulfuric acid salts and alkylaryl ether sulfuric acid salts; and phosphoric acid ester salts such as alkylphosphoric acid salts and alkylether phosphoric acid salts.

A nonionic surfactant is a surfactant that is not dissociated in aqueous solution, yet contains a weak hydrophilic group such as a hydroxyl group, an ether group or an ester group. Therefore, nonionic surfactants may be classified into ether-type surfactants, such as alkyl and alkylaryl polyoxyethylene ethers and alkylaryl formaldehyde condensate polyoxyethylene ethers; ester ether-type surfactants, such as polyoxyethylene ethers of glycerine ester, polyoxyethylene ether of sorbitan ester and polyoxyethylene ethers of sorbitol ester; ester-type surfactants, such as polyethylene glycol fatty acid esters, glycerine esters, and sorbitan esters; and amide-type (nitrogen-containing type) surfactants, such as fatty acid alkanolamides and polyoxyethylene alkyl amines. Because of the characteristic of the nonionic surfactant being non-dissociative in aqueous solution, nonionic surfactants, except for the ester-type surfactants, may be used in a broad range of pH and may be used in parallel with other ionic surfactants, and therefore, have a wide range of applications.

Particularly in embodiments of the present invention, one or more surfactants are used for the preparation of a polyester particle dispersion. Although the surfactant may be used singly, it is preferable to use a combination of an anionic surfactant and a nonionic surfactant.

The anionic surfactant not only aids the dispersion of polyester resin particles, but also charges the surfaces of the particles, so that the polyester resin has suitable physical properties for use in the toner preparation based on the emulsion polymerization. In other words, the polyester resin particles are negatively charged at their surfaces and show the same physical properties as latex used as a binder resin for a toner obtained by the emulsion polymerization, and therefore, readily agglomerates with the use of an agglomerating agent. Examples of the anionic surfactant that may be used in the preparation method of embodiments of the present invention are sodium dodecyl sulfate, sodium 4-dodecylbenzene sulfonate, and sodium polyoxyethylene lauryl ether sulfate (EMAL 27®).

Although the anionic surfactant may be used singly, it may also be used in combination with a nonionic surfactant as a vehicle for providing dispersability to polyester resin particles. As aforementioned, because of the non-dissociative nature in aqueous solution, the nonionic surfactant may be used together with other surfactants. Besides the dispersability, the nonionic surfactant is advantageously used for separating the resin dissolvent, which is used in replacement of the organic solvent, from the polyester resin particles. As a rule, a gum or a wood rosin used as the resin dissolvent is generally dark. Thus, when the gum or the wood rosin is used as it is, it is suitable only for the black toner, and not for the color toner. Here, the used resin dissolvent must be removed. Therefore, with the help of the nonionic surfactant, the resin dissolvent is more effectively separated from the polyester resin particles. Suitable nonionic surfactants are polyoxylethylene sorbitan monolaurate (Tween 20®) and alkylaryl polyester alcohol (Triton X-100®).

Even though the anionic surfactant and the nonionic surfactant may be used singly, it is more preferable to use them in combination because when the anionic surface is used singly, the dispersion may become ionic, which is suitable for toner preparation based on the emulsion polymerization, but still additional additive(s) is required to separate the resin dissolvent. Similarly, when the nonionic surfactant is used singly, although the resin dissolvent could be easily separated, the physical properties thereof (e.g., dispersability) are not satisfactory compared with other ionic surfactants. Thus, its utilization is considerably low.

For the foregoing reasons, the present invention provides for using the anionic surfactant and the nonionic surfactant at the same time, or in combination.

As for the dispersion medium for dispersing the resin particles, distilled water is used.

The reverse-neutralized resin particle is surrounded by a surfactant and has a negative charge overall, so that it may be aggregated by an aggregating agent. Moreover, the particle size of the resin obtained by embodiments of the present invention method is in nanometer unit, which is much smaller than the particle size (1 μm) of the dispersion obtained by the related art preparation method of polyester resin. A thusly prepared dispersion is similar to latex for use in the emulsion polymerization, and it is mixed with the aggregation agent and other additives to form toner particles.

Furthermore, a polyester particle dispersion is obtained by embodiments of the preparation method of the present invention.

Preferably, the particle size of the polyester is smaller than 1 μm, more preferably, in a range from about 50 nm to about 400 nm. Also, the glass transition temperature of the resin particle is preferably about 40° C. to about 100° C. This range is carefully determined because when the glass transition temperature is lower than about 40° C., the thermal resistance/viscosity of the final toner prepared by using the polyester particles of embodiments of the present invention are insufficient, whereas when the glass transition temperature is higher than about 100° C., the final toner shows reduced fixability.

The polyester particles are mixed with a colorant, a charge control agent, an aggregating agent and other additives under predetermined conditions, and produce a dry toner including the polyester resin obtained by embodiments of the present invention.

The preparation methods of a polyester resin and its particles will now be described in greater detail in reference to the examples below.

### EXAMPLES

The following examples describe preparation methods of a polyester resin particle dispersion, respectively. In particular, Examples 2 to 4 are modified from Example 1 by applying different anionic surfactants and nonionic surfactants. Meanwhile, Comparative Example 1 suggests a preparation method of polyester resin particles without using nonionic surfactants.

### Example 1

100 g of a polyester binder resin, 100 g of a rosin, and 0.5 g of DBTO were put into a reactor, and stirred and reacted at a temperature between about 235° C. and about 245° C. for about 2 hours at about 250 rpm. When the mixture became transparent, it was cooled to about 150° C., and 40 g of maleic acid was added thereto. Then, the temperature was raised to a range of about 235° C. to 245° C., and the secondary depolymerization reaction was continued for about 3 hours.

When the reaction time was over, 35 g of bisphenol A-EO was added thereto, and the reaction was further continued for about 5 hours at a temperature between about 235° C. and about 245° C. When the polycondensation reaction proceeded to a predetermined degree, the reaction product was cooled to about 85° C. Then, a basic solution prepared by dissolving 35 g of sodium hydroxide in 200 g of distilled water was added thereto and stirred for about 30 minutes at about 400 rpm, to prepare a water-soluble polyester resin dispersion.

Next, 40 g of HCl, and a mixture of 0.8 g to 20 g of sodium dodecyl sulfate and 5 g of Tween 20® as a surfactant were dissolved in 800 g of distilled water, to prepare an acidic aqueous solution. At room temperature (about 25° C.), the polyester resin dispersion was stirred at a high speed, and the acidic aqueous solution was slowly added to the dispersion, to produce polyester resin particles having a volume average particle diameter of about 253 nm. When the reaction product was set aside for several hours, it was observed that the polyester resin particles were effectively separated from the rosin.

### Example 2

The procedure for preparation of the particles in Example 1 was repeated, except that a mixture of 30 g of sodium 4-dodecylbenzene sulfonate and 3 g of Tween 20® was used as a surfactant, instead of the mixture of sodium dodecyl sulfate and Tween 20®. A volume average particle diameter was about 380 nm. Also, when the reaction product was set aside for several hours, it was observed that the polyester resin particles were effectively separated from the rosin.

### Example 3

The procedure for preparation of the particles in Example 1 was repeated, except that a mixture of 25 g of EMAL 27® and 5 g of Tween 20® was used as a surfactant instead of the mixture of sodium dodecyl sulfate and Tween 20®. A volume average particle diameter was about 251 nm. Also, when the reaction product was set aside for several hours, it was observed that the polyester resin particles were effectively separated from the rosin.

### Example 4

The procedure for preparation of the particles in Example 1 was repeated, except that a mixture of 20 g of EMAL 27® and 20 g of Triton X-100® was used as a surfactant instead of the mixture of sodium dodecyl sulfate and Tween 20®. A volume average particle diameter was about 265 nm. Also, when the reaction product was set aside for several hours, it was observed that the polyester resin particles were effectively separated from the rosin.

### Comparative Example 1

The procedure for preparation of the particles in Example 1 was repeated, except that 25 g of sodium dodecyl sulfate was used instead of the mixture of sodium dodecyl sulfate and Tween 20®. A volume average particle diameter was about 155 nm. Also, when the reaction product was set aside for several hours, it was observed that the polyester resin particles and the rosin were not separated but uniformly dispersed.

### EVALUATION

Measurement of Volume Average Particle Diameter

The volume average particle diameter of the toner particles was measured using an instrument HORIBA910, the particle size distribution analyzer, from HORIBA INSTRUMENTS, INC. The measurement results are shown in Table 1 below.

TABLE 1

| | | Volume | Separation |
|---|---|---|---|
| | | average | state from |
| | | particle | resin dis- |
| | Surfactant | diameter (nm) | solvent (Y/N) |
| Example 1 | Sodium dodecyl | 253 | Yes |
| | sulfate/Tween 20 ® | | |
| Example 2 | sodium 4- | 380 | Yes |
| | dodecylbenzene | | |
| | sulfonate/ | | |
| | Tween 20 ® | | |
| Example 3 | EMAL 27 ®/ | 251 | Yes |
| | Tween 20 ® | | |
| Example 4 | EMAL 27 ®/ | 265 | Yes |
| | Triton X-100 ® | | |
| Comparative | Sodium dodecyl | 155 | No |
| Example 1 | sulfate | | |

As may be seen in Table 1, when a surfactant is used for the preparation of a polyester particle dispersion of embodiments of the present invention, the size of the prepared particles in each example was in nm. Therefore, it was confirmed that the surfactant was responsible for controlling the particle size.

In addition, it was observed that when a mixture of the anionic surfactant and the nonionic surfactant was used and the prepared polyester particle dispersion was set aside for a predetermined number of hours, the polyester resin particles were easily separated from the resin dissolvent. However, when only the nonionic surfactant was used, the polyester resin particles and the resin dissolvent were not separated from each other.

Therefore, compared with the related art binder resin using a polyester resin, the polyester resin particles obtained by embodiments of the present invention have sizes in nm units, which is even smaller than the requirement particles size (i.e., ≦1 μm) for the emulsion polymerization. Also, by using a mixture of the anionic surfactant and the nonionic surfactant, the polyester particles were readily separated from the resin dissolvent being used, being suitable for use in the production of a color toner.

As explained earlier, for the preparation of a polyester resin as the binder resin for use in the production of a toner, embodiments of the present invention utilized the resin dissolvent for dissolving the polyester resin, not an organic solvent as in the related art. Thus, it becomes possible to avoid the usage of hazardous and environmentally unfriendly organic solvents that cause severe damage to the body of the user and environment contamination problems. Moreover, the particle size of the resin obtained by embodiments of the preparation method of the present invention is much smaller than 1 μm, so the resin particles are suitable for the toner production based on the emulsion polymerization. Furthermore, by using a mixture of two different kinds of surfactants, the polyester resin particles may be easily separated from the resin dissolvent being used.

The foregoing example and advantages are merely exemplary and are not to be construed as limiting the present invention. The present teaching may be readily applied to other types of apparatuses. Also, the description of the examples of the present invention is intended to be illustrative, and not to limit the scope of the claims, and many alternatives, modifications, and variations will be apparent to those skilled in the art without departing from the principles and spirit of the invention, the scope of which is defined in the claims and their equivalents.

What is claimed is:

1. A preparation method of a polyester particle dispersion, the method comprising:
under predetermined depolymerization conditions, mixing a polyester resin, a resin dissolvent and a polycondensation catalyst to depolymerize the polyester resin to form a first reaction mixture;
adding a first monomer to the first reaction mixture to form a second reaction mixture;
under predetermined polymerization conditions, adding a second monomer to the second reaction mixture to polymerize the depolymerized polyester resin with the first and second monomers to form a polymerized reaction product;
adding a neutralizing agent to neutralize the polymerized reaction product and form a neutralized mixture;
adding a reverse-neutralizing agent to reverse neutralize the neutralized mixture and form a reverse neutralized mixture; and
adding a mixture of an anionic surfactant and a nonionic surfactant to the reverse-neutralized mixture.

2. The method according to claim 1, wherein the polyester resin is selected from the group consisting of bisphenol A polyester resins and polyethylene terephthalate (PET) polyester resins.

3. The method according to claim 1, wherein the resin dissolvent is selected from the group consisting of gum rosins, wood rosins, tall rosins, rosin esters, and C₅ to C₉ petroleum resins.

4. The method according to claim 1, wherein the polycondensation catalyst is dibutyltinoxide (DBTO).

5. The method according to claim 1, wherein the first and second monomers are polycondensing monomers.

6. The method according to claim 1, wherein the first monomer is selected from the group consisting of maleic acid, phthalic anhydride, isophthalic acid, and terephthalic acid.

7. The method according to claim 1, wherein the second monomer is selected from the group consisting of ethylene glycol, propylene glycol, and bisphenol A alkylene oxide.

8. The method according to claim 1, wherein the neutralizing agent is a basic compound.

9. The method according to claim 8, wherein the basic compound is selected from the group consisting of sodium hydroxide, potassium hydroxide, lithium hydroxide, calcium hydroxide, sodium carbonate, and ammonia.

10. The method according to claim 1, wherein a ratio of the resin dissolvent to the polyester resin ranges from 1:9 to 9:1 by weight.

11. The method according to claim 1, wherein the reverse-neutralizing agent is an acid.

12. The method according to claim 11, wherein the acid is hydrochloric acid.

13. The method according to claim 1, wherein the anionic surfactant is selected from the group consisting of sodium dodecyl sulfate, sodium 4-dodecylbenzene sulfonate, and sodium polyoxyethylene lauryl ether sulfate.

14. The method according to claim 1, wherein the nonionic surfactant is selected from the group consisting of polyoxylethylene sorbitan monolaurate and alkylaryl polyester alcohol.

15. A polyester particle dispersion obtained by the preparation method of claim 1.

16. The polyester particle dispersion according to claim 15, wherein the polyester particle dispersion has polyester particles with a diameter from about 50 nm to about 400.

17. The polyester particle dispersion according to claim 15, wherein the dispersion has polyester particles with a glass transition temperature in a range from about 40° C. to about 100° C.

18. A method of preparing polyester resin particles for a dry toner, comprising:
mixing a polyester binder resin, a resin dissolvent and a polycondensation catalyst to form a mixture to depolymerize the polyester resin, stirring at approximately 150-350 rpm and reacting at a temperature between 235° C. and 245° C. for a predetermined period of time until the mixture becomes transparent;
cooling the mixture to a predetermined temperature in a temperature range between 100° C. and 200° C. and adding a first monomer;
performing a secondary depolymerization reaction by heating the mixture with the first monomer at approximately 235° C. to 245° C. for a predetermined period of time;
forming a polycondensed product by adding a second monomer to the secondary depolymerization reaction and continuing to heat at approximately 235° C. to 245° C. for a predetermined period of time;
cooling the polycondensed product to a predetermined temperature in a temperature range between 50° C. and 100° C. and adding a basic solution to neutralize the polycondensed product and stirring for less than an hour at about 300-500 rpm; and
adding, to the neutralized polycondensed product, a mixture of an anionic surfactant and a nonionic surfactant, a predetermined amount of acid, and a predetermined amount of distilled water and stirring in a temperature range of 15° C. to 35° C. to prepare a dispersion of particles having a predetermined volume average particle diameter.

19. The method according to claim 18, wherein the polyester binder resin is selected from the group consisting of bisphenol A polyester resins and polyethylene terephthalate (PET) polyester resins.

20. The method according to claim 18, wherein the resin dissolvent is selected from the group consisting of gum rosins, wood rosins, tall rosins, rosin esters, and C₅ to C₉ petroleum resins.

21. The method according to claim 18, wherein the polycondensation catalyst is dibutyltinoxide (DBTO).

22. The method according to claim 18, wherein the first and second monomers are polycondensing monomers.

23. The method according to claim 18, wherein the first monomer is selected from the group consisting of maleic acid, phthalic anhydride, isophthalic acid, and terephthalic acid.

24. The method according to claim 18, wherein the second monomer is selected from the group consisting of ethylene glycol, propylene glycol, and bisphenol A alkylene oxide.

25. The method according to claim 18, wherein the basic solution includes a basic compound selected from the group consisting of sodium hydroxide, potassium hydroxide, lithium hydroxide, calcium hydroxide, sodium carbonate, and ammonia.

26. The method according to claim 18, wherein a ratio of the resin dissolvent to the polyester resin ranges from 1:9 to 9:1 by weight.

27. The method according to claim 18, wherein the acid is hydrochloric acid.

28. The method according to claim 18, wherein the anionic surfactant is selected from the group consisting of sodium dodecyl sulfate, sodium 4-dodecylbenzene sulfonate, and sodium polyoxyethylene lauryl ether sulfate.

29. The method according to claim 18, wherein the nonionic surfactant is selected from the group consisting of polyoxylethylene sorbitan monolaurate and alkylaryl polyester alcohol.

30. A polyester particle dispersion obtained by the preparation method of claim 18.

31. The polyester particle dispersion according to claim 30, wherein the polyester particle dispersion has particles with a diameter from about 50 nm to about 400 nm.

32. The polyester particle dispersion according to claim 30, wherein the polyester particle dispersion has particles with a glass transition temperature in a range from about 40° C. to about 100° C.
